(19) United States
(12) Patent Application Publication
(10) Pub. No.: US 2018/0163612 A1
(43) Pub. Date: Jun. 14, 2018

(54) METHOD FOR OPERATING AN INTERNAL COMBUSTION ENGINE

(71) Applicant: GE Jenbacher GMBH & CO OG, Jenbach (AT)

(72) Inventors: Ettore MUSU, Modena (IT); Friedrich GRUBER, Hippach (AT); Nikolaus SPYRA, Hippach (AT); Georg TINSCHMANN, Schwaz (AT)

(21) Appl. No.: 15/577,834

(22) PCT Filed: May 4, 2016
(86) PCT No.: PCT/AT2016/050125

§ 371 Date: Nov. 29, 2017

(30) Foreign Application Priority Data
May 29, 2015 (AT) A 343/2015

(51) Int. Cl. F02B 37/00; F02D 41/00; F02D 9/04; F02B 37/007; F02B 37/013

(52) U.S. Cl. CPC F02B 37/005; F02D 41/006; F02D 9/04; F02M 26/06; F02D 41/0065; F02B 37/013; F02B 37/007

(57) ABSTRACT

A method of operating an internal combustion engine, whereby a quantity of an exhaust gas remaining in combustion chambers of the internal combustion engine is varied, whereby the quantity of remaining exhaust gas is varied by controlling or regulating an exhaust-gas backpressure (pₒᵤₜₗₑₜ) adjacent to outlet valves of the combustion chambers of a turbo-compound system arranged in an exhaust pipe of the internal combustion engine.

### BACKGROUND OF THE INVENTION

The invention relates to a method for operating an internal combustion engine, in particular a dual-fuel internal combustion engine, which is operated according to the Premixed Charge Compression Ignition (PCCI) combustion method.

### BRIEF DESCRIPTION OF THE INVENTION

Dual-fuel internal combustion engines are internal combustion engines that typically operate in two operating modes. We differentiate an operating mode with a primary liquid fuel supply (“liquid operation” for short; in the case of the use of diesel as a liquid fuel, it is called “diesel operation”) and an operating mode with primarily gaseous fuel supply, in which the liquid fuel serves as a pilot fuel for initiating combustion (also called “pilot operation” for short).

In the design of internal combustion engines, there is a conflict of objectives between the reduction of nitrogen oxides and the reduction of particulate emissions, and in gas engines also the reduction of THCs (total of unburned hydrocarbons).

The PCCI (Premixed Charge Compression Ignition) combustion method is a promising approach for achieving high-efficiency and low-emission combustion.

In PCCI combustion method, a lean mixture of air and an incombustible fuel (e.g. gas) is ignited by injecting a small quantity of ignitable fuel (e.g. diesel). An internal combustion engine operated according to the PCCI method must be classified as a special variant of a dual-fuel internal combustion engine.

Such a dual-fuel internal combustion engine thus has a PCCI operating mode. If it is operated according to the PCCI combustion method, this is referred to as the PCCI operating mode.

The combustion in the PCCI combustion method runs at lower local temperatures than conventional combustion in diesel or gas engines and is further characterized by the avoidance of locally very rich or lean areas, such that the formation of nitrogen oxides (NOX), soot and THC emissions is reduced significantly.

A determining parameter for regulating the combustion is the quantity and temperature of the recirculated or retained exhaust gas within the cylinder. It is possible to differentiate between internal and external exhaust-gas recirculation (EGR).

In external exhaust-gas recirculation, exhaust gas is removed from the exhaust tract and fed via a line back to the intake tract. The external exhaust-gas recirculation allows a simple and effective cooling of the exhaust gas via heat exchangers.

In the case of low-pressure exhaust-gas recirculation (LP EGR), the removal takes place downstream of the turbine of the turbocharger, and the introduction takes place in the intake tract upstream of the compressor of the turbocharger.

In the case of high-pressure exhaust-gas recirculation (HP EGR), the removal takes place upstream of the turbine of the turbocharger, and the introduction takes place in the intake tract downstream of the compressor of the turbocharger.

In the internal exhaust-gas recirculation, the combustion gases are either retained in the cylinder or briefly pushed into the inlet duct and sucked back again. Also possible is the temporary opening of the outlet valve(s) during the inlet stroke, such that exhaust gas is sucked back into the cylinder.

As a rule, the inlet and outlet valve opening times must be modified for the internal exhaust-gas recirculation and for setting the desired remaining gas content.

The retention of exhaust gas (internal EGR) is an integral part of the PCCI combustion method.

The internal EGR and the external HP EGR have in common that the quantity of remaining gas or recirculated exhaust gas is influenced by the pressure level upstream of the turbine and also upstream of the cylinder.

An increase in the pressure level upstream of an exhaust-gas turbine (i.e. the exhaust gas backpressure), as well as modified valve opening times, in particular in the four-stroke process, inherently results in losses in the expulsion stroke and thus reduces the efficiency.

An object of an embodiment of the invention is to provide a regulating method or an internal combustion engine by which the disadvantages of the prior art are avoided.

Since the quantity of the remaining exhaust gas is varied by controlling or regulating an exhaust-gas backpressure adjacent to outlet valves of the combustion chambers of a turbo-compound system arranged in an exhaust pipe of the internal combustion engine, the exhaust-gas recirculation rate can be controlled or regulated elegantly.

When this disclosure refers to an “exhaust-gas recirculation rate”, this also actually includes exhaust-gas retention for internal EGR.

An embodiment of the invention primarily aims to influence the internal EGR rate.

As explained above, internal exhaust-gas recirculation takes place by retaining or re-aspirating exhaust gases from the inlet or outlet tract of an internal combustion engine. Controlling of regulating the exhaust-gas backpressure directly influences the internal EGR rate, whereby increased exhaust-gas backpressure results in an increased internal EGR rate. Conversely, a reduced exhaust-gas backpressure causes a reduced EGR rate.

It is provided that the variation of the exhaust-gas backpressure exerted by the turbo-compound system takes place by controlling or regulating a braking torque of a generator of the turbo-compound system.

The control or regulation of the braking torque of the generator can be performed e.g. by influencing the excitation current. It must be understood that an increase in the braking torque exerted by the generator is also equivalent to an increase in the power available from the generator.

Increasing the braking torque of the turbo-compound system increases the exhaust-gas backpressure exerted by the turbo-compound system, thus increasing the quantity of recirculated/retained exhaust gas.

A particular advantage of the solution is that the increase in the exhaust-gas backpressure implies only a small loss of energy, since the turbo-compound system generates more electrical power at increased exhaust-gas backpressure.

It can be provided that, in the case of a parallel arrangement of the turbo-compound system to a turbocharger, more particularly in PCCI mode, the exhaust-gas backpressure is additionally controlled or regulated by actuating a valve arranged in the exhaust pipe downstream of the turbocharger.

More particularly, the internal combustion engine is operated in PCCI operating mode.

It should be noted that the internal exhaust-gas recirculation is particularly relevant in PCCI operating mode. A retention of exhaust gas through internal EGR (“hot EGR”) supports this combustion method.

An external EGR is particularly relevant for the diesel operating mode.

By means of this invention, an internal combustion engine can be operated particularly favorably in both operating modes (PCCI operating mode and diesel operating mode).

As is known per se, in addition to the measures described above, variable valve control times for the inlet valves and/or outlet valves of the combustion chambers can also be used to control the internal EGR.

The internal combustion engine is designed as a stationary gas engine, particularly as part of a genset for decentralized power generation. Applications in the marine and locomotive sector are also conceivable.

### BRIEF DESCRIPTION OF THE DRAWINGS

The invention will be described in more detail with reference to the figures. The figures show the following:

FIG. 1 the pV diagram of a power stroke of a 4-stroke internal combustion engine without internal exhaust-gas recirculation and with a high-efficiency turbocharger

FIG. 2 the pV diagram of a power stroke of a 4-stroke internal combustion engine with internal EGR and increased pressure level upstream of the exhaust-gas turbine (PCCI operating mode),

FIG. 3 the pV diagram of a power stroke of a 2-stroke internal combustion engine with internal EGR and increased pressure level upstream of the exhaust-gas turbine (PCCI operating mode),

FIG. 4 an arrangement of an internal combustion engine with a turbo-compound system in a first exemplary embodiment,

FIG. 5 an arrangement of an internal combustion engine with a turbo-compound system in a further exemplary embodiment,

FIG. 6 an arrangement of an internal combustion engine with a turbo-compound system according to a further exemplary embodiment and

FIG. 7 an arrangement of an internal combustion engine with two-stage turbocharging and a turbo-compound system according to a further exemplary embodiment.

### DETAILED DESCRIPTION OF THE INVENTION

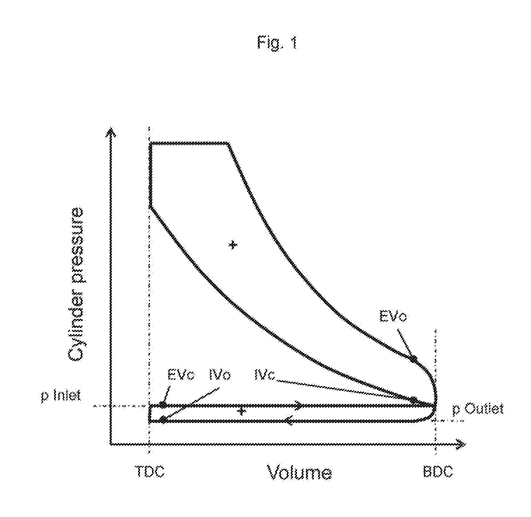

FIG. 1 shows the power stroke of a 4-stroke internal combustion engine without internal exhaust-gas recirculation and a turbocharger with high efficiency in the pV diagram. The Y-axis shows the cylinder pressure and the X-axis shows the volume. An internal combustion engine with the characteristics shown here has a positive scavenging gradient, i.e. the pressure level upstream of the cylinder pᵢₙₗₑₜ (is greater than the pressure level downstream of the cylinder, pₒᵤₜₗₑₜ, i.e. the exhaust-gas backpressure which prevails downstream of the outlet valves and upstream of the exhaust-gas turbine. Due to the positive scavenging gradient, the loop generated by the expulsion and intake stroke (the so-called low-pressure cycle) also contributes to the power generation, as it is generally known.

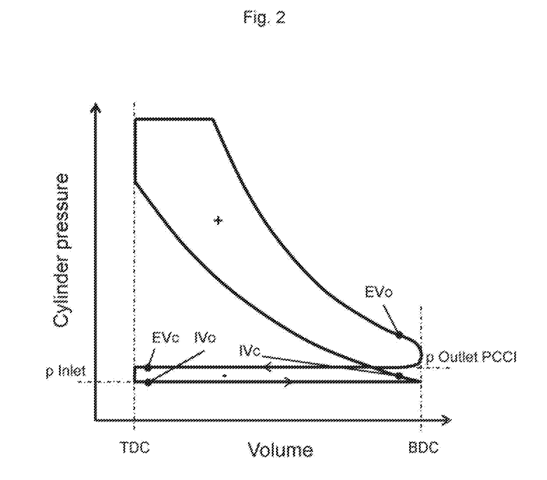

FIG. 2 shows the representation of a power stroke of an internal combustion engine, which is operated in the PCCI mode in the pV diagram in analogy to the representation of FIG. 1. It can be seen that here the pressure level upstream of the cylinder is less than the exhaust-gas backpressure p_{outlet PCCI}, i.e. the internal combustion engine has a negative scavenging gradient. As a result, work must be performed for the intake and expulsion cycle. By superimposing the representations of FIG. 1 and FIG. 2, it can be seen that, compared to the normal operating mode of FIG. 1 on the one hand, the performance obtained therein is lost and, in addition, the power shown in FIG. 2 for the expulsion or intake stroke must be provided.

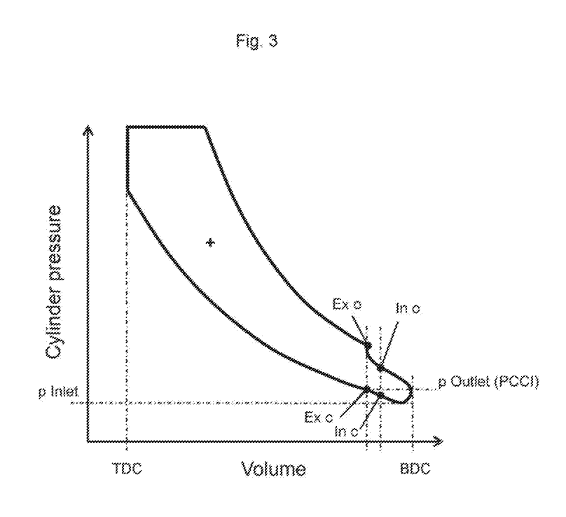

FIG. 3 shows the pV diagram of a power stroke of a 2-stroke internal combustion engine with internal EGR and increased pressure level upstream of the exhaust-gas turbine (PCCI operating mode). We can immediately see the inherent advantages of the 2-stroke method with regard to the work to be applied in the intake and expulsion cycle. A charge cycle loop, as in 4-stroke, is missing; therefore, the charge cycle work is much smaller.

The representations in FIGS. 1 to 3 are textbook knowledge and help to explain the motivation of an embodiment of this invention, namely to reduce the losses in the intake or expulsion stroke, also known as the low-pressure cycle. An embodiment of the invention also relates to 2-stroke and 4-stroke internal combustion engines.

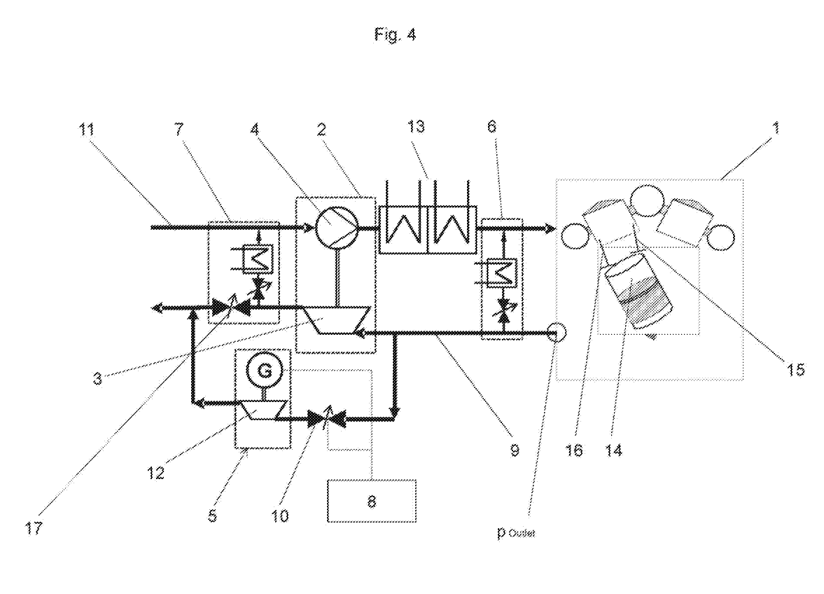

FIG. 4 shows an arrangement according to a first exemplary embodiment. The arrangement shows an internal combustion engine 1, a turbocharger 2 and a turbo-compound system 5 in an arrangement parallel to the turbocharger 2.

The internal combustion engine 1 generally comprises a plurality of combustion chambers 14, only one of which is shown for reasons of clarity.

The combustion chambers 14 are connected via at least one inlet valve 15 to the supply line 11 and via at least one outlet valve 16 to the exhaust pipe 9.

Turbo-compound systems are known in principle from the prior art. In this case, the exhaust gases of an internal combustion engine can be expanded in a power turbine and the enthalpy of the exhaust gas is converted into mechanical or electrical energy when coupling the power turbine to a generator.

The turbocharger 2 comprises the exhaust-gas turbine 3 and the compressor 4 coupled via a shaft to the exhaust-gas turbine 3. Air or a mixture entering via the supply line 11 is compressed by the compressor 4 and supplied via the heat exchanger 13 of the internal combustion engine 1. The exhaust gases of the internal combustion engine 1 are fed into the exhaust-gas turbine 3, where they are expanded and flow away with reduced pressure.

Also shown is a high-pressure exhaust-gas recirculation 6 which is arranged upstream of the exhaust-gas turbine 3. From the high-pressure exhaust-gas recirculation 6, exhaust gas can be diverted from the exhaust pipe 9 to be supplied to the inlet side of the internal combustion engine 1. The high-pressure exhaust-gas recirculation 6 consists of a variable valve and a heat exchanger, such that the recirculated exhaust gases can be cooled and supplied to the inlet of the internal combustion engine 1.

Also shown is a second exhaust-gas recirculation, the optional low-pressure exhaust-gas recirculation 7. This is arranged downstream of the exhaust-gas turbine 3, and can remove the exhaust gas present there at a lower pressure level than upstream of the exhaust-gas turbine 3 and supply the mixture or air supply line upstream of the compressor 4. To influence the quantity of exhaust gas recirculated via the low-pressure exhaust-gas recirculation 7 into the supply line 11, two shut-off valves are provided. Valve 17 connects the outlet of the exhaust-gas turbine 3 with the outlet of the exhaust gases from the exhaust pipe 9 (e.g. to a chimney or an exhaust aftertreatment) and allows a throttling or shut-off of the exhaust pipe 9. A further valve is provided in the connection to the supply line 11, thus making it possible to regulate the quantity of exhaust gas recirculated via the low-pressure exhaust-gas recirculation 7 in the interaction of the valve positions.

The latter valve also allows the complete blocking of the flow path to the supply line 11 and may be provided in all exemplary embodiments.

For the high-pressure exhaust-gas recirculation 6, the same applies mutatis mutandis.

The dotted boxes around the internal combustion engine 1, turbocharger 2, high-pressure exhaust-gas recirculation 6 and low-pressure exhaust-gas recirculation 7 express that they are functional units.

Parallel to the exhaust-gas turbine 3, an electrical turbo-compound system 5 is arranged. Upstream of the turbo-compound system 5, the valve 10 is arranged. The turbo-compound system 5 consisting of a turbine 12 and a generator G is controlled by the control/regulating device 8. The control/regulating device 8 can now control or regulate the electrical turbo-compound system 5 (hereinafter referred to as “control”) such that the turbo-compound system 5 is operated e.g. at a constant rotational speed. The procedure can be performed via the generator G. Another possibility would be an adjustment of the incoming flow of the turbine 12.

Furthermore, via the control/regulating device 8, by actuating the valve 10, the pressure level prevailing immediately upstream of the turbine of the turbo-compound system 5 pressure level or the exhaust gas mass flow flowing through the turbine 12 of the turbo-compound system 5 can be controlled.

In such a way, the exhaust-gas backpressure pₒᵤₜₗₑₜ applied from the turbo-compound system 5 can be controlled or regulated. Controlling of regulating the exhaust-gas backpressure pₒᵤₜₗₑₜ directly influences the internal EGR rate, whereby increased exhaust-gas backpressure results in an increased internal EGR rate. Conversely, a reduced exhaust-gas backpressure causes a reduced EGR rate. In such a way, the EGR rate can be controlled elegantly by means of the turbo-compound system 5.

If e.g. the valve 10 is opened, not all of the exhaust gas coming from the internal combustion engine 1 flows to the exhaust-gas turbine 3, but a portion thereof also flows to the turbo-compound system 5. By varying the partial quantity of exhaust gas flowing through the turbo-compound system 5, the pressure level upstream of the exhaust-gas turbine 3 can be influenced. Thus, an increase of the exhaust gas quantity flowing through the turbo-compound system 5 causes a reduction of the pressure level upstream of the exhaust-gas turbine 3.

In practice, the turbo-compound system 5 and the turbocharger 3 will be matched such that a control reserve exists in both directions, i.e. in the direction of an increase of the exhaust gas mass flow flowing through the turbo-compound system 5 and in the direction of a reduction of the same. The backpressure of the turbo-compound system 5 can be controlled or regulated via the brake torque of the generator G and the valve 10.

Through the variable valve 10 designed according to a variant, the turbo-compound system 5 can be regulated to a constant speed. The variable valve 10 thus allows the operation of the electrical turbo-compound system 5 at a constant speed and the regulation of the pressure upstream of the exhaust-gas turbine 3.

In a variant of the exemplary embodiment, the valve 10 upstream of the turbo-compound system 5 is designed as a non-variable valve. In the variant with the valve 10 designed e.g. as a simple flap valve, the turbo-compound system 5 has a variable speed in operation.

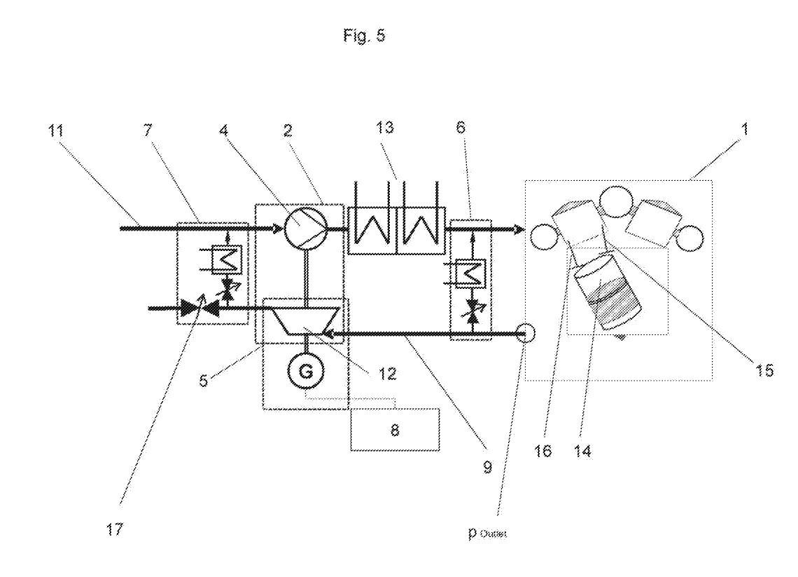

FIG. 5 shows a further exemplary embodiment of the arrangement of an internal combustion engine with turbo-compound system for implementing the method according to an embodiment of the invention. In the exemplary embodiment according to FIG. 5, the turbo-compound system 5 and the turbocharger 2 are combined: the turbine 12 of the turbo-compound system 5 replaces the exhaust-gas turbine 3 of the turbocharger 2.

The turbine 12, together with the coupled generator G, forms the turbo-compound system 5; at the same time, the turbine 12 is coupled via a shaft to the compressor 4 and forms the turbocharger 2 together with the compressor 4.

In this exemplary embodiment, the turbo-compound system 5 is, on the one hand, coupled via a shaft to the compressor 4 and, on the other hand, is coupled to the generator G. Also shown is the high-pressure exhaust-gas recirculation 6 and an optional low-pressure exhaust pipe 7. To regulate the latter, the same as stated in FIG. 4 applies.

In this exemplary embodiment, the exhaust-gas backpressure exerted by the turbo-compound system 5 (and thus the EGR rate) is varied as the resistance exerted by the generator G on the turbo-compound system 5 is varied.

If a high braking torque acts from the generator G to the turbo-compound system 5, then a higher pressure level prevails in the exhaust pipe 9 than in the case of a lower braking torque from the generator G.

Thus, the pressure level in the exhaust pipe 9 and thus the exhaust-gas recirculation rate can also be controlled with the arrangement of FIG. 5.

Particularly, in the exemplary embodiment according to FIG. 5, the pressure level in the exhaust pipe 9, and thus the exhaust-gas recirculation rate, can be varied when the generator G is designed as a variable generator. This means that by controlling e.g. the excitation current, the braking torque exerted by the generator G can be varied.

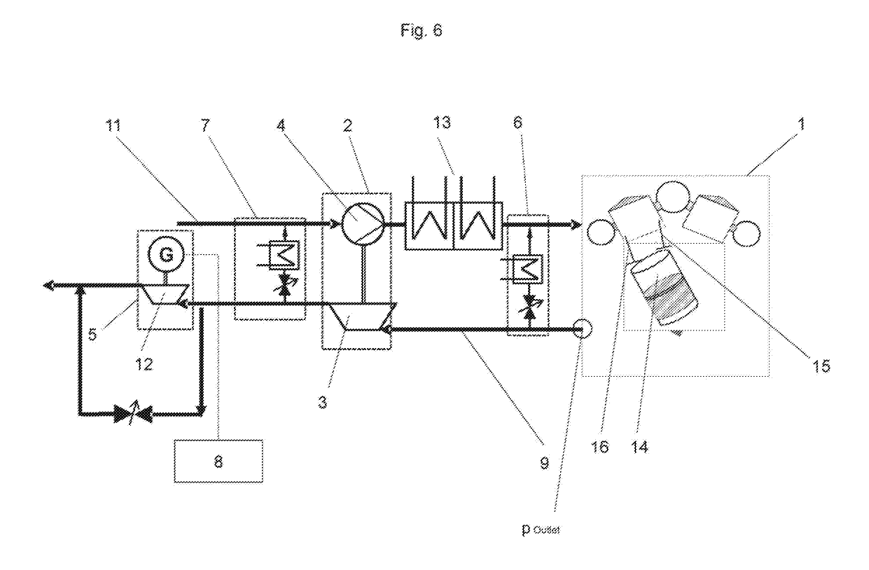

FIG. 6 shows a further exemplary embodiment in which the turbo-compound system 5 is arranged in series to the exhaust-gas turbine 3 downstream of the exhaust-gas turbine 3. In this case, an operation of the turbo-compound system 5 affects the pressure level between the exhaust-gas turbine 3 and the turbo-compound system 5, but also affects the pressure level upstream of the exhaust-gas turbine 3, and thus the exhaust-gas backpressure pₒᵤₜₗₑₜ and the quantity of internal EGR are changed.

The turbo-compound system 5 includes an adjustable bypass. By means of a variable valve, the bypass can, as needed, be opened fully, closed fully or take up intermediate positions. In the fully opened position of the bypass, the exhaust gas will mostly flow around the turbo-compound system 5.

The bypass creates an opportunity, especially in transient mode (i.e. with rapid load fluctuations), to respond quickly.

With increasing load demand, e.g. the bypass would be fully opened to make all the exhaust-gas energy available to generate charge-air pressure.

In one variant, the exemplary embodiment can be designed with two-stage turbocharging (two turbochargers in series).

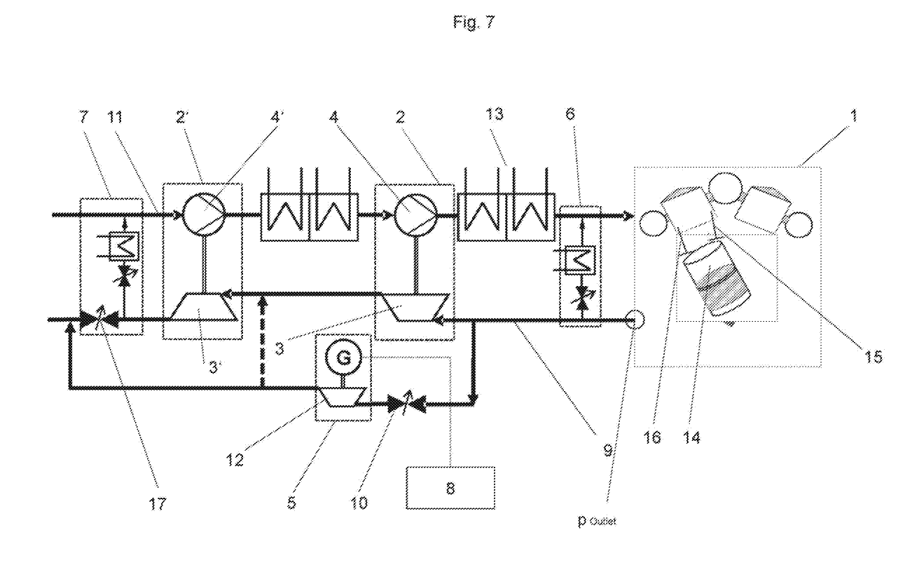

FIG. 7 shows an arrangement with two-stage turbocharging, whereby two turbochargers 2, 2′ are arranged in series. According to this exemplary embodiment, the turbo-compound system 5 is arranged between the input side of the turbine 3 of the turbocharger 2 (here acting as a high-pressure turbocharger) and the output side of the turbine 3′of the turbocharger 2′ (low-pressure turbocharger). Alternatively, the turbo-compound system 5 can also be arranged between the input and output sides of the turbine 3 (high-pressure turbocharger).

As explained with reference to the above exemplary embodiments, the brake torque of the turbo-compound system 5 can also be varied here via the control/regulating device 8. Thus, the pressure level in the exhaust pipe 9 upstream of the high-pressure exhaust-gas turbine 3 and consequently the recirculated/retained exhaust gas quantity can be varied.

As a possible variant, a flow path is entered as a dotted line downstream of the turbo-compound system 5, which connects the downstream side of the turbo-compound system 5 with the inlet of the turbine 3′of the turbocharger 2′(low-pressure turbocharger). In other words, in this variant the turbo-compound system 5 only bridges the high-pressure turbocharger. This provides the opportunity to work off exhaust gas from the turbo-compound system 5 still in the low-pressure turbocharger.

It applies to all exemplary embodiments that the turbine 12 of the turbo-compound system 5 itself can be designed with two stages.

The dotted box around the internal combustion engine 1 shows the functional unit. The natural structure is such that the supply line 11 leads to the inlet valves 15 and the outlet valves 16 are connected to the exhaust pipe 9. The exhaust-gas backpressure pₒᵤₜₗₑₜ is between the outlet valves 16 and the exhaust-gas turbine 3 (FIGS. 4, 6 and 7) or the exhaust-gas turbine 12 (FIG. 5).

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of operating an internal combustion engine, wherein a quantity of an exhaust gas remaining in combustion chambers of the internal combustion engine is varied, wherein the quantity of remaining exhaust gas is varied by controlling or regulating an exhaust-gas backpressure adjacent to outlet valves of the combustion chambers of a turbo-compound system arranged in an exhaust pipe of the internal combustion engine.

2. A method according to claim 1, wherein the variation of the exhaust-gas backpressure exerted by the turbo-compound system takes place by controlling or regulating a braking torque of a generator of the turbo-compound system.

3. A method according to claim 1, wherein the quantity of the exhaust gas recirculated from the exhaust pipe into the combustion chambers is controlled or regulated by varying the exhaust-gas backpressure exerted by the turbo-compound system.

4. A method according to claim 1, wherein, in the case of a parallel arrangement of the turbo-compound system to a turbocharger, preferably in a PCCI mode, the exhaust-gas backpressure is additionally controlled or regulated by actuating a valve arranged in the exhaust pipe downstream of the turbocharger.

5. A method according to claim 1, wherein the internal combustion engine is operated in PCCI operating mode.

6. An internal combustion engine with
a supply line for air or mixture,
an exhaust pipe for discharging exhaust gas from the internal combustion engine, wherein exhaust gas from the exhaust pipe can be guided into the supply line,
a turbo-compound system arranged in the exhaust pipe,
combustion chambers for combustion of the fuel-air mixture supplied via the supply line,
a control/regulating device,
wherein the control/regulating device is designed such that, by the control/regulating device intervening in the turbo-compound system, the quantity of the exhaust gas recirculated by the exhaust pipe into the combustion chambers of the internal combustion engine can be controlled or regulated.

7. An internal combustion engine according to claim 6, wherein at least one turbocharger is provided, to which exhaust gases can be supplied from the internal combustion engine and from which a compressed mixture or air can be supplied to the internal combustion engine, wherein the turbo-compound system is arranged parallel to the at least one turbocharger.

8. An internal combustion engine according to claim 6, wherein two series-connected turbochargers are provided, to which exhaust gases can be supplied from the internal combustion engine, and from which a compressed mixture or air can be supplied to the internal combustion engine, wherein the turbo-compound system connects the input of the first turbocharger with the output of the second turbocharger or the input of the first turbocharger to the output of the first turbocharger.

9. An internal combustion engine according to claim 6, wherein at least one turbocharger is provided, to which exhaust gases can be supplied from the internal combustion engine and from which a compressed mixture or air can be supplied to the internal combustion engine, wherein the turbo-compound system is arranged in series to the at least one turbocharger.

10. An internal combustion engine according to claim 6, wherein at least one turbocharger is provided, to which exhaust gases can be supplied from the internal combustion engine and from which a compressed mixture or air can be supplied to the internal combustion engine, wherein the turbine of the turbo-compound system is arranged instead of the turbine of the at least one turbocharger.
